(19) United States
(12) Patent Application Publication
(10) Pub. No.: US 2012/0059690 A1
(43) Pub. Date: Mar. 8, 2012

(54) INCENTIVIZING PARTICIPATION IN AN INNOVATION PIPELINE

(75) Inventors: John Ruckart, Atlanta, GA (US); Robert A. Koch, Norcross, GA (US); Patrick J. Asher, Boerne, TX (US); Louis W. Danuser, Austin, TX (US); Steven Neil Tischer, Atlanta, GA (US)

(73) Assignee: AT&T INTELLECTUAL PROPERTY I, L.P., Reno, NV (US)

(21) Appl. No.: 12/875,396

(22) Filed: Sep. 3, 2010

(51) Int. Cl. G06Q 30/00; G06F 15/16; G06Q 99/00

(52) U.S. Cl. 705/14.1; 705/319; 709/204

(57) ABSTRACT

Detecting and devaluing non-pertinent input in an online social network includes setting triggers for user conduct that includes evaluating a unique content submission submitted to the online social network and detecting, at a tangible host server, when a trigger is activated based on user conduct by a first user. The first user is penalized based on the user conduct. An initial weighting value is assigned to the unique content submission submitted to the online social network based on the first user evaluating the unique content submission.

### BACKGROUND

1. Field of the Disclosure

The present disclosure relates to incentivizing participation in an innovation pipeline. More particularly, the present disclosure relates to the manner in which ideas submitted to the innovation pipeline are presented to users and in which user participatory activities related to evaluating the ideas are regulated.

2. Background Information

Entities with interests in developing individuals' ideas into innovations sometimes establish mechanisms by which ideas can be submitted for review. These ideas may be presented in an organized manner to assist a user in finding relevant or interesting ideas to review. The entities may provide incentives for individuals to submit ideas and to review ideas. Sometimes, the allocation of incentives is regulated to prevent misuse of the system. The mechanisms by which the ideas are reviewed may be accessible remotely from an organizational entity that supports and maintains these mechanisms.

### BRIEF DESCRIPTION OF THE DRAWINGS

FIG. 1 shows an exemplary general computer system that includes a set of instructions for incentivizing participation in an innovation pipeline as described herein;

FIG. 2A shows a process flow diagram for applying tripwires to user participatory activity in the incentivized innovation pipeline, according to an aspect of the present disclosure;

FIG. 2B shows an exemplary system diagram for applying tripwires to user participatory activity in the incentivized innovation pipeline, according to an aspect of the present disclosure;

FIG. 3A shows an exemplary map specifying details of user participatory activity in the incentivized innovation pipeline, according to an aspect of the present disclosure;

FIG. 3B shows an exemplary map specifying details of ad hoc group formation in the incentivized innovation pipeline, according to an aspect of the present disclosure;

FIG. 4A shows an exemplary process flow diagram for investing and escrowing indicators of valuation in a prediction market for the incentivized innovation pipeline, according to an aspect of the present disclosure;

FIG. 4B shows an exemplary leader board for the incentivized innovation pipeline, according to an aspect of the present disclosure;

FIG. 5A shows a first exemplary distributed instance of the incentivized innovation pipeline, according to an aspect of the present disclosure;

FIG. 5B shows a second exemplary distributed instance of the incentivized innovation pipeline, according to an aspect of the present disclosure; and

FIG. 5C shows a third exemplary distributed instance of the incentivized innovation pipeline, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

According to a non-limiting embodiment of the present disclosure, ideas are submitted for development into innovations by one or more members of an organizational entity. The ideas are submitted in the form of unique content submissions. The unique content submissions may include audio, graphical, video, text and software submissions. The organization entity may be any of the following, but not limited to: a corporation, an educational institution, a religious organization, a non-profit organization and a partnership. The unique content submissions are submitted via a website interface, such as a social networking interface, accessible to some or all members of the organizational entity. In one non-limiting embodiment, unique content submissions are classified, labeled and/or categorized based on a category of subject matter of a corresponding idea or innovation. The submissions may be classified, labeled and/or categorized according to subject matter content either by the submitters or by a reviewer at an initial stage of review.

Eligible members of the organizational entity vote on the unique content submissions. Voting methods may include any method of indicating a preference including, but not limited to: straight voting, ranking, and/or allocating a value to the unique content submissions. The voting results for unique content submissions are subsequently analyzed to determine which of the unique content submissions are winners and which of the winners match criteria specified by the organizational entity.

According to an aspect of the presently claimed disclosure, a method for detecting and devaluing non-pertinent input in an online social network includes setting triggers for user conduct that includes evaluating a unique content submission submitted to the online social network includes detecting, at a tangible host server, when a trigger is activated based on user conduct by a first user. The method includes penalizing the first user based on the user conduct. The method includes adjusting an initial weighting value assigned to the unique content submission submitted to the online social network based on the first user evaluating the unique content submission.

According to another aspect of the present disclosure, the triggers are set in the online social network.

According to yet another aspect of the present disclosure, the unique content submission is evaluated by at least one of a review, a vote and a comment submitted by the first user via the online social network.

According to still another aspect of the present disclosure, the trigger is activated when the user conduct conforms to at least one of evaluating more than a predetermined number of unique content submissions submitted to the online social network within a specified time period, evaluating the unique content submissions using less than a predetermined number of characters and using specified content in evaluating the unique content submissions.

According to an aspect of the present disclosure, each of the review, the vote and the comment are associated with a different incentive.

According to another aspect of the present disclosure, the first user loses a predetermined incentive amount from accumulated earned incentives when the trigger is activated.

According to yet another aspect of the present disclosure, the method includes scoring the unique content submission in accordance with the adjusted weighting value.

According to still another aspect of the present disclosure, an evaluation of the unique content submission by the first user is scored differently than an identical evaluation of the unique content submission by a second user.

According to an aspect of the present disclosure, a method for providing the users with a vote corresponding to earned incentives for performing online activities includes accepting from the users, at a tangible host server, votes related to unique content submissions provided by the users. The method includes ranking selected unique content submissions based on the votes and provisionally evaluating ranked unique content submissions without further consideration of the votes. The method includes graduating at least one unique content submission from provisionally evaluated unique content submissions. The method includes adding to the earned incentives of users who voted for a graduated unique content submission and detracting from the earned incentives of users who voted for provisionally evaluated unique content submissions that were not graduated.

According to another aspect of the present disclosure, the method includes investing in at least one ranked selected unique content submission by applying, by the users, a subset of the earned incentives to the at least one ranked selected unique content submission.

According to yet another aspect of the present disclosure, the method includes suspending voting and investing during provisionally evaluating the ranked unique content submissions.

According to still another aspect of the present disclosure, the method includes adding to the earned incentives of the users who invested in the graduated unique content submission, based on the subset of the earned incentives and detracting from the earned incentives of users who invested in the provisionally evaluated unique content submissions that were not graduated, based on the subset of earned incentives.

According to an aspect of the present disclosure, the ranked unique content submissions are displayed on a leader board.

According to another aspect of the present disclosure, the leader board is associated with a hash tag identifier.

According to yet another aspect of the present disclosure, a method for presenting unique content submissions to users in a social network includes associating the unique content submissions with identifiers that correspond to characteristics of a plurality of authors of the unique content submissions and obtaining characteristics of a first user in the social network. The method includes obtaining a plurality of the unique content submissions from the plurality of authors. The method includes determining, at a tangible host server, at least one best match among the unique content submissions for a first user based on obtained characteristics of the first user and presenting at least one best matched unique content submission to the first user preferentially over other unique content submissions via an online social networking interface based on the obtained characteristics of the first user and the identifiers corresponding to authors of the at least one best matched unique content submission.

According to still another aspect of the present disclosure, the method includes presenting at least one unique content submission to the first user based on characteristics of activity of the first user in the social network observed over a predetermined time period and the characteristics of the activity include categories associated with evaluated unique content submissions.

According to an aspect of the present disclosure, a method for evaluating unique content submissions generated by users includes collecting the unique content submissions, via at least one hardware resource, using a social networking website interface and accepting reviews, votes and comments on the unique content submissions, via the at least one hardware resource, so as to rate the unique content submissions, using the social networking website interface. The method includes provisionally evaluating the unique content submissions based on the reviews, votes and comments and the social networking website interface is accessible by at least one remote user located remotely from an organizational entity.

According to another aspect of the present disclosure, the at least one remote user accesses the social networking website interface via a cloud computing service established by the organizational entity, and the at least one hardware resource is located locally to the organizational entity.

According to yet another aspect of the present disclosure, the at least one hardware resource is located remotely from the organizational entity and is proximate to the at least one remote user, the at least one hardware resource instantiates social networking software corresponding to the social network website interface, and the at least one remote user accesses the social networking website interface via the at least one hardware resource.

According to still another aspect of the present disclosure, the at least one hardware resource comprises a secured hardware device.

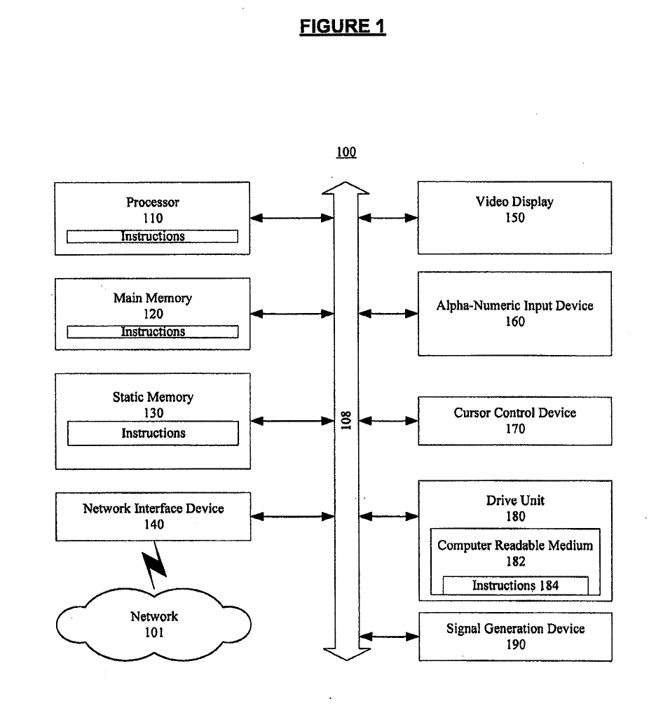

FIG. 1 is an illustrative embodiment of a general computer system that includes a set of instructions for performing processes in an incentivized innovation pipeline as described herein. The general computer system is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices. For example, the computer system 100 may include or be included within any one or more of the computers, servers, systems, or communication networks described herein.

In a networked deployment, the computer system may operate in the capacity of a server or as a client user computer in a server-client user network environment, or as a peer computer system in a peer-to-peer (or distributed) network environment. The computer system 100, or portions thereof, can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, for example, a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an alpha-numeric input device 160, such as a keyboard, another input device (not shown), such as a remote control device having a wireless keypad, a keyboard, a microphone coupled to a speech recognition engine, a camera such as a video camera or still camera, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. A computer-readable medium 182 is a tangible article of manufacture, from which sets of instructions 184 can be read. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations, or combinations thereof.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

In an initial stage, ideas are submitted to a social networking interface of an incentivized innovation pipeline. Users associated with an organizational entity submit these ideas, or unique content submissions, that are presented to other users via the social networking interface (e.g., a website) who are able to provide feedback in a manner analogous to a crowd of individuals. Unique content submissions include opportunities for capital investment. The other users associated with the organizational entity review, comment and vote on the unique content submissions. Feedback and approval or disapproval results from the crowd may be used to determine which ideas are moved along and developed as innovations in the incentivized innovation pipeline.

According to a non-limiting embodiment of the present disclosure, user behavior is monitored and regulated with respect to voting on the unique content submissions via the social networking interface. Information associated with reviewing, commenting and voting on the unique content submissions is used to regulate such behavior of the users, to form ad hoc groups and concepts, and to obtain and design future tripwires. The social networking interface via which the unique content submissions are submitted, and the peer review processes via which the unique content submissions are reviewed speed the velocity of developing ideas into products.

Tripwires and Recommendation Engine

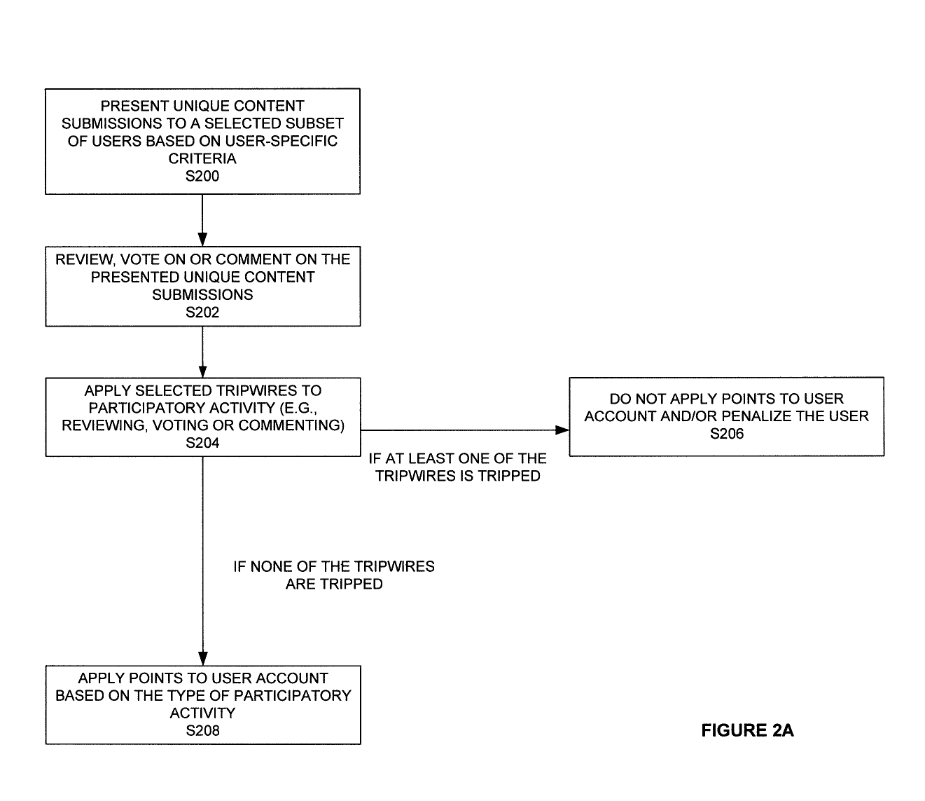

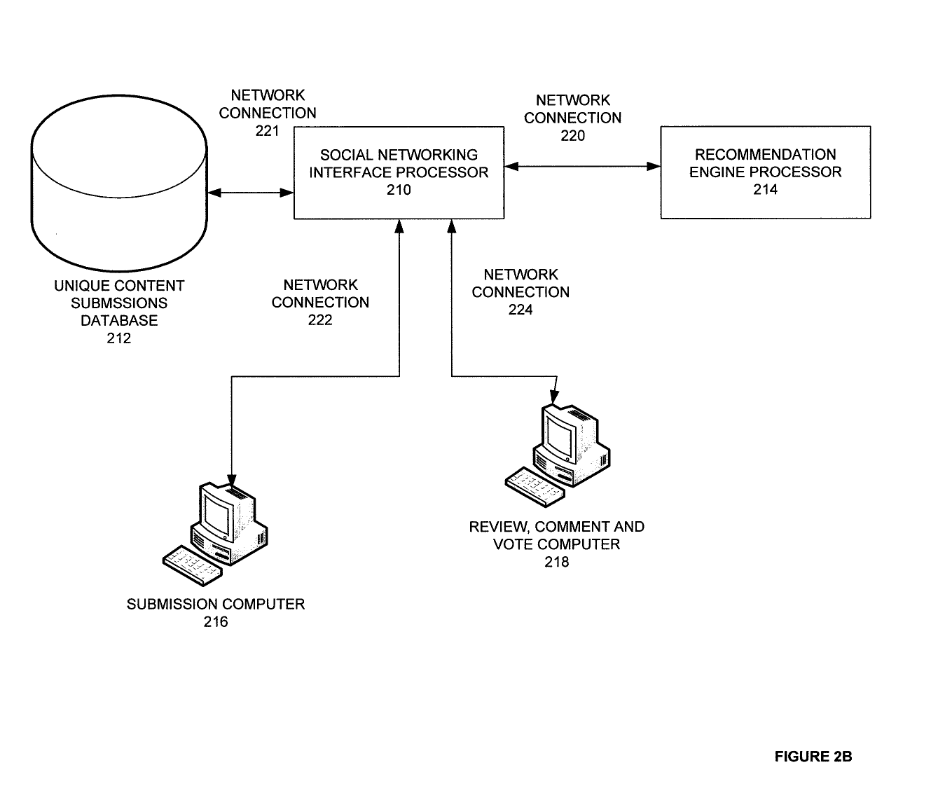

In FIG. 2A, a process flow diagram for applying tripwires to evaluate user participatory activity in a social networking environment for analyzing unique content submissions is shown. In step S200, unique content submissions are presented to a selected subset of users based on predetermined, user-specific criteria. A recommendation engine, implemented in conjunction with the social networking interface, determines which of the unique content submissions submitted to the social networking interface are possibly of interest to a particular user (i.e., a reviewing user). In one non-limiting embodiment, a user searches for unique content submissions to review, vote or comment on based on keywords entered by the user. In another non-limiting embodiment, the user selects a number of categories of interest and the recommendation engine presents unique content submissions categorized in the selected categories of interest.

In yet another non-limiting embodiment, the recommendation engine gauges user participatory activity over a predetermined time period and presents unique content submissions based on at least one of: a user identifier, a user profile and observed user participatory activity. The user identifier may be used to obtain a user's position in an organizational entity hierarchy and their job description. For example, the user identifier may indicate that the user is a tertiary level decision-maker in the mid-Atlantic region that makes intellectual property decisions. Accordingly, a relatively large proportion of unique content submissions are presented, by the recommendation engine, to the user (i.e., because the user makes decisions as to whether the unique content submissions are worthy of patenting). As another example, the recommendation engine may determine that there are other users in the organizational entity that are closely situated with respect to the user (e.g., as determined according to an organizational and hierarchical structure) and that voted on ideas that the user may be interested in. Accordingly, the recommendation engine presents these unique content submissions that other, similarly situated users also reviewed, voted or commented on.

For example, a user “Ron Wilson” may have a user profile that indicates that he is a member of a wireless devices group and that his interests lie in the area of customer care agents. In one non-limiting embodiment, the user profile is automatically configured for the user (i.e., Ron Wilson in the above-noted example). In another non-limiting embodiment, the user manually configures various portions of the user profile. Accordingly, the recommendation engine will present unique content submissions submitted by members of the wireless devices group, unique content submissions related to wireless devices (even if not submitted by a member of the wireless devices group), and unique content submissions related to customer care agents.

In another non-limiting embodiment, the recommendation engine may learn more about the subjects of the user's participatory activity over time (e.g., days, weeks or months). As yet another example, Ron Wilson may comment on ideas associated with mobile device applications. That is, he may also vote on unique content submissions submitted by groups that are tangentially related, or not at all related to his group, in addition to unique content submissions that are submitted by members of his group (i.e., the wireless devices group). Therefore, the recommendation engine presents unique content submissions submitted by members of the wireless devices group, unique content submissions submitted by members of the mobile devices applications group, and any unique content submissions that are related to mobile device applications and wireless devices, irrespective of the group from which they originate. For example, another member, “Jane P. Brown” associated with a network security group may have secondary interests in creating mobile applications for cellular phones, even though she is not a member of the mobile device applications group. Accordingly, ideas submitted by other users, such as Jane P. Brown, related to Ron Wilson's participatory activities, are observed over time and are presented, in the form of unique content submissions, to Ron Wilson by the recommendation engine.

As yet another example, recommendations are based on level of interest in an idea. For example, the recommendation engine determines whether the user merely voted on an idea, or whether the user submitted unique content submissions related to the idea, commented on an idea, or followed the idea. That is, each different type of user participatory activity in the social networking environment signifies a different level of user interest in the idea, and therefore affects either the unique content submissions or the priority of unique content submissions presented by the recommendation engine. In one non-limiting embodiment, the recommendation engine provides a level of confidence with respect to one or more of its recommendations.

In step S202, one of the selected subset of users reviews, comments or votes on the presented unique content submissions. In step S204, tripwires are applied to voting, reviewing, and commentary participatory activity by the user. Tripwires are rules used to detect and remediate non-pertinent voting, reviewing and commentary activity in the social networking environment. Tripwires include detecting non-pertinent activity based on any of the following, but not limited to: brevity of user participatory activity, a time interval between user participatory activities and “red flag” input in the user participatory activity. For example, if the user comments on a predetermined number (e.g., ten) of unique content submissions by typing phrases having less than a specified number of characters (e.g., less than 50 characters) into a comment dialog box or the like, then the social networking environment determines that the user's commentary is not as valuable as commentary provided by other users to rate and rank the unique content submission. As another example, if the user reviews, votes or comments on unique content submissions more than a predetermined number of times in a specified time period (e.g., five unique content submissions in sixty seconds), then the social networking environment will determine that the user is most likely not reading or fully analyzing the presented unique content submissions in order to make informed voting decisions. As yet another example, conducting an intelligent scan of the content of the review or commentary reveals when the user uses phrases such as “good job” or “great idea!”. The lack of specificity in these phrases provide relatively little value to another user voting on the unique content submission, nor to any decision-maker attempting to determine whether the unique content submission is worthy of capital investment. In one non-limiting embodiment, a tripwire is tripped if the user “down votes” a comment on a unique content submission, but does not penalize the user if the user down votes the unique content submission itself.

As will be understood by one of ordinary skill in the art, the above-described tripwires are exemplary. In a non-limiting embodiment, the social networking interface collects and analyzes user participatory activity over a time period and develops new tripwires and modifies old tripwires. If none of the above-described tripwires are tripped, then the process proceeds to step S208 in which points corresponding to a level of participatory activity are applied to the user's account. For example, the user might receive 5 points for voting on a unique content submission, 10 points for commenting on the unique content submission and 15 points for reviewing the unique content submission. As will be understood by one of ordinary skill in the art, any number of points may be assigned to each participatory activity. In particular, the points assigned to one participatory activity may be greater than points assigned to another participatory activity. For example, a weight associated with reviews may be greater than a weight associated with votes. Accordingly, a weighted determination is made to decide which ideas will percolate to the top of a leader board and therefore, may be potentially worthy of possible of capital investment. In one non-limiting embodiment of the present disclosure, a tangible or monetary incentive is provided instead of points. In another non-limiting embodiment, votes, reviews and comments are evenly weighted. In yet another non-limiting embodiment, down votes and up votes (for the unique content submission) are evenly weighted. In still another non-limiting embodiment, down votes are weighted more than up votes (for the unique content submission).

If the user trips one or more tripwires, the process proceeds to step S206, in which it is determined that points are not to be allocated to the user's account. In one non-limiting embodiment of the present disclosure, the user is penalized for engaging in non-pertinent activity. Penalizing the user affects the user's reputation. The user is penalized by a loss of accumulated incentives (i.e., points in the user's account). For example, a penalized user loses points or tangible items awarded for pertinent participatory activity. If non-pertinent activity is detected with respect to a particular unique content submission, this activity does not count toward a vote total for the unique content submission.

In FIG. 2B, a system diagram including components involved in regulating user participatory activity in a social networking environment for analyzing unique content submissions is shown. A social networking interface is implemented on a social networking interface processor 210. The social network interface processor 210 is connected, via network connection 221, to a unique content submissions database 212 that stores unique content submissions. Unique content submissions are submitted, via a network connection 222, by a submission computer 216, operated by one or more users. A recommendation engine is implemented on a recommendation engine processor 214. The recommendation engine processor 214 obtains unique content submissions from the unique content submissions database 212 via the social networking interface processor 210 by sending a request over a network connection 220. A review, comment and vote computer 218 accesses the social networking interface processor 210 via a network connection 224 to review, vote and comment on unique content submissions presented by the recommendation engine processor 214 via the social networking interface processor 210.

As will be understood by one of ordinary skill in the art, the network connections 220, 221, 222 and 224 are any one or combination of the following, including, but not limited to: an Internet connection, an intranet connection, a local area network connection, a wide area network connection, a wired network connection, a wireless network connection and a virtual private network connection. Although the various processors and computers 210, 212, 214, 216 and 218 are shown as separate computers, some or all of the features of two or more of these components as described herein may be performed by a single computer or processor. Further,

Visualizing User Activity and Ad Hoc Group Formation

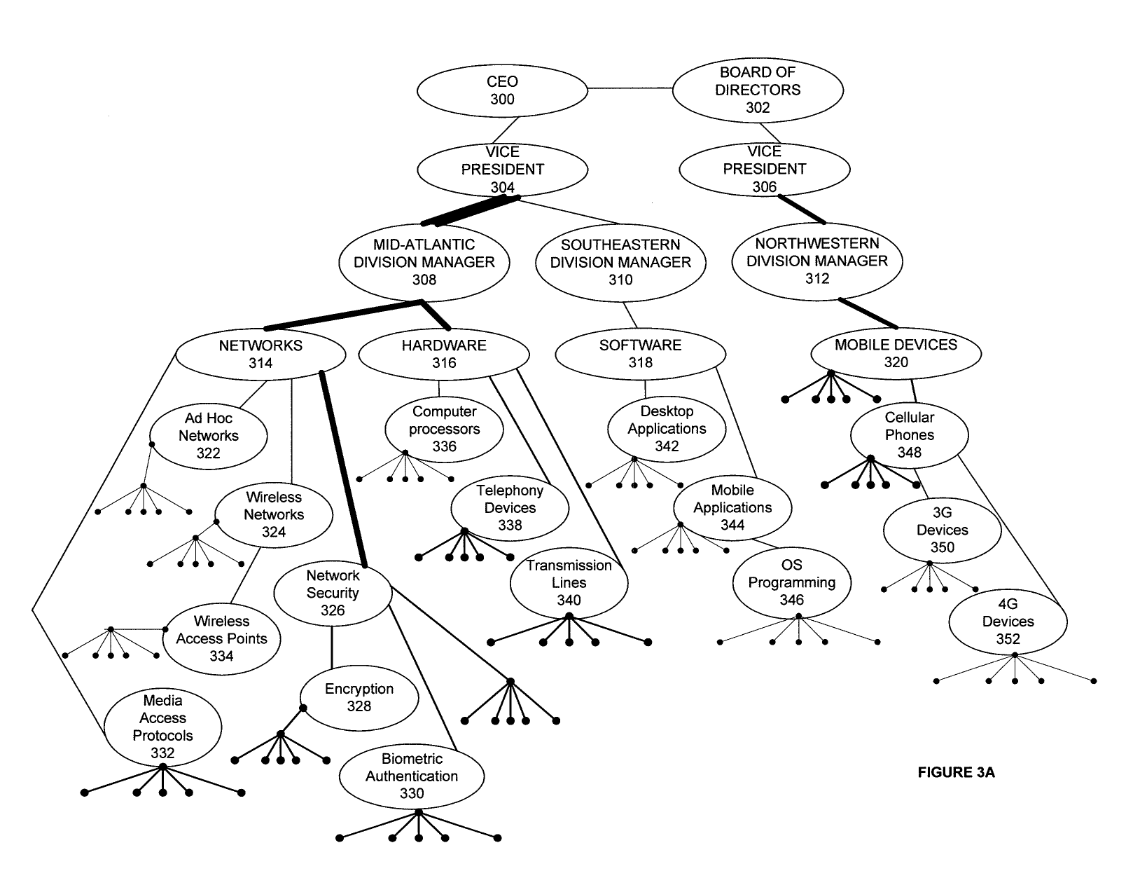

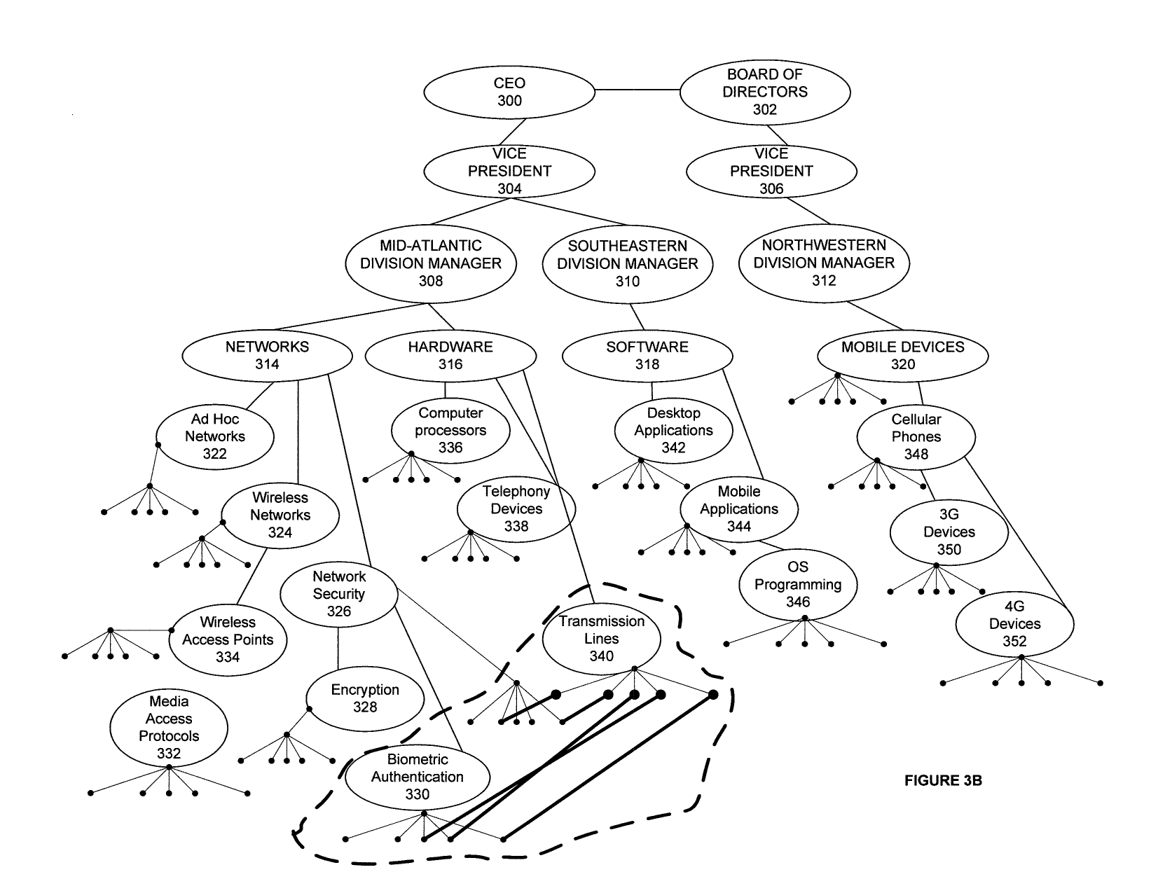

In FIG. 3A, a map specifying details of user participatory activity in a social networking environment is shown. While the map shown in FIG. 3A is divided organizationally and by technology area, the map may also be divided geographically, or by any other logical construct. The weight of the lines connecting each organizational level, or each technology area shown in FIG. 3A is illustrative of a level of user participatory activity in the social networking environment. In one non-limiting embodiment, user participatory activity is indicated by color, pattern or any other visual indicator. A level of user participatory activity is determined by accumulating a number of votes, reviews and comments by a user, group, technology area, division or any other appropriate group. In a non-limiting embodiment, the level of user participatory activity is determined based on other criteria.

As illustrated in FIG. 3A, vice president 304, mid-Atlantic division manager 308 and networks group 314 are associated with a high level of user participatory activity in the incentivized innovation pipeline, as indicated by a line weight. This is because users in the media access protocols group 332, encryption group 328, biometric authentication group 330 and network security group 326 all engaged in significant user participatory activity. Northwestern division manager 312 is associated with a moderate amount of user participatory activity, in particular, from users in the mobile devices group 320 and the cellular phones group 348. Southeastern division manager 310 is not associated with any user participatory activity.

The level of user participatory activity is used to determine how active or inactive groups relate to each other, as will be described in further detail with respect to FIG. 3B. In one non-limiting embodiment, the map is used to determine why some groups are more active than other groups. The weight of the lines also represents how many active users report to a higher level of authority. In another non-limiting embodiment, the map is displayed in a manner similar to a heat map; “cooler” colors indicate lesser levels of user activity and “warmer” colors indicate greater levels of user activity.

In FIG. 3B, a map specifying details of ad hoc group formation is shown. Ad hoc groups represent asynchronous collaboration associated with unique content submissions and associated user participatory activity. In particular, bolded lines shown in FIG. 3B indicate that a user from one end point of the line reviewed, voted or commented on a unique content submission presented by a user at another end point of the line. The dashed lines indicate that groups that were formed as a result of user participatory activity in the social networking environment. As can be seen in FIG. 3B, lines connecting biometric authentication group 330 and transmission lines group 340 and lines connecting network security group 326 and transmission lines group 340 indicate that an ad hoc group including members from each of these groups was formed.

A Prediction Market, a Leaderboard and Seasons

Users are incentivized to participate in reviewing, commenting and voting on unique content submissions based on, in one embodiment, a point system. As will be understood by one of ordinary skill in the art, incentives are not limited to point systems. For example, incentives may be monetary awards, tangible goods, or exchange of services. Points obtained by participating in the social networking environment are invested in “a prediction market” corresponding to the unique content submissions. The above-noted prediction market functions in a manner similar to a financial stock market or stock exchange. In this regard, users of the social networking interface obtain points to “invest” by participating via the social networking interface. As will be understood by one of ordinary skill in the art, points, incentives and awards are not limited to the above-noted forms of participation. In one non-limiting embodiment, users obtain points by submitting unique content submissions. Each form of participation may carry a different weight and therefore, may be assigned a different number of points. The system keeps track of points for each user in a user account. Each user may use any portion of their points to “buy” a share in one or more unique content submissions.

In the prediction market, the unique content submissions are correlated with a value that represents a level of user activity surrounding the unique content submission, relative to other unique content submissions. Unique content submissions for which greater positive activity occurs are ranked higher than unique content submissions for which no user participatory activity occurs, or for which negative user participatory activity occurs. The crowd of users evolves ideas based on the unique content submissions for eventual development into a marketable product.

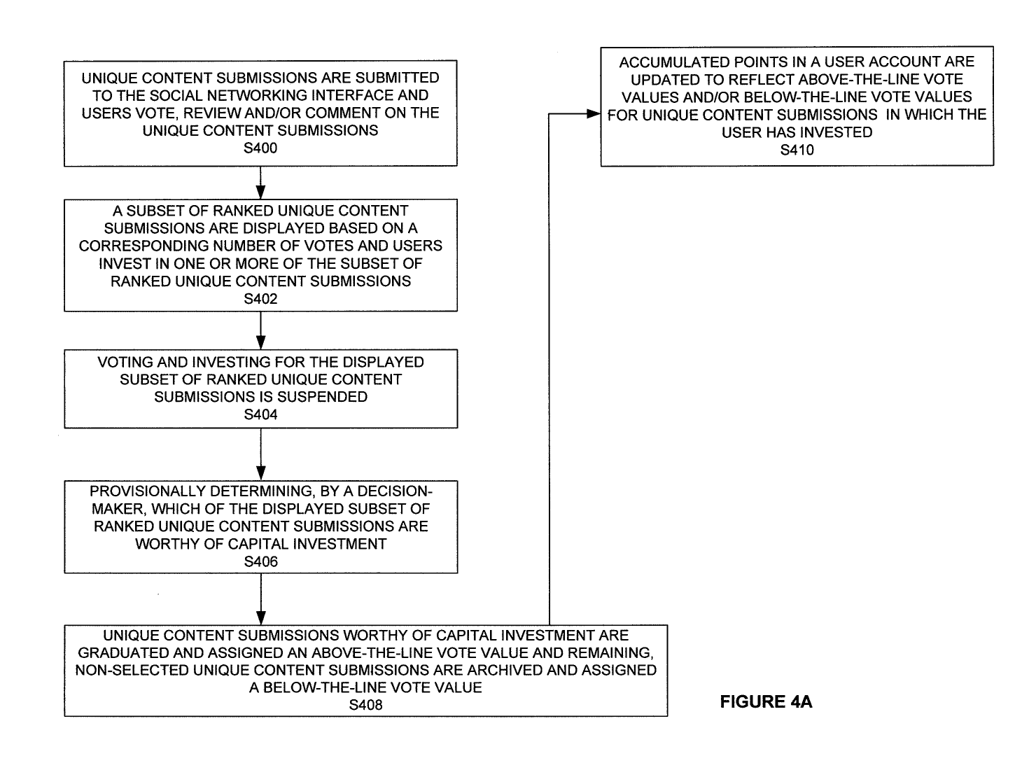

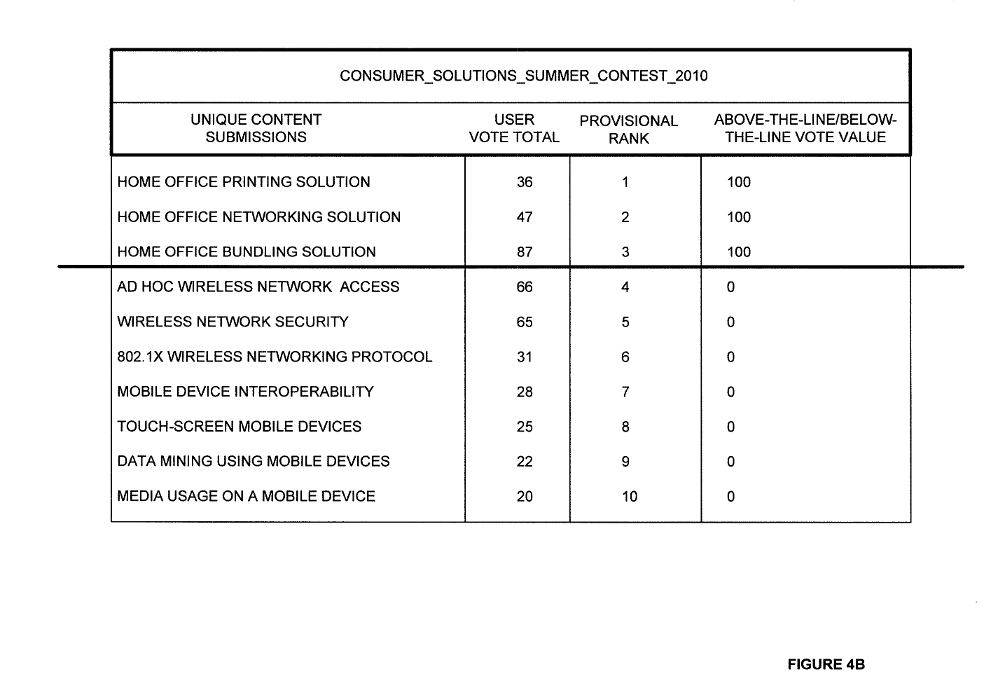

In FIG. 4A, a process flow diagram for investing in a prediction market is shown. In step S400, unique content submissions are submitted to the social networking environment and users vote, review and/or comment on the unique content submissions. In step S402, unique content submissions are ranked based on accumulated number of votes, and a subset of the ranked unique content submissions are displayed, by season, on a leader board accessible via the social networking interface of the incentivized innovation pipeline. The season indicates a fiscal quarter, or other time period relevant to capital investment by the organizational entity. Initially, in a first round, unique content submissions are ranked in ascending order according to a number of votes. A predetermined number (e.g., 10) of the top-ranked ideas are obtained and, in one embodiment, are presented on a leader board. Also in step S402, the users may optionally “invest” in the top-ranked ideas by applying a portion of accumulated earned incentives to one or more of the unique content submissions. As will be understood by one of ordinary skill in the art, the users may apply a portion of accumulated earned incentives to unranked unique content submissions as well. Investing earned incentives is discussed in further detail below.

Voting and investing for the top ten (or other predetermined number) unique content submissions is subsequently suspended in step S404. The total predetermined number of top-ranked unique content submissions are presented to a decision-maker in the organizational entity. In one embodiment, the decision-maker is a chief financial officer or a venture capitalist. In another embodiment, the decision-maker is a regional or division manager. In step S406, the decision-maker provisionally decides which of the top-ranked unique content submissions are worthy of capital investment, based on goals, investment strategies and other criteria for the organizational entity.

For example, a leader board may indicate three ideas related to wireless networking, four ideas related to home office solutions, and three ideas related to mobile devices. The decision-maker may decide that only the home office solutions are worthy of pursuing, at least for the current season. The organizational entity may have recently launched a wireless cellular device product and a mobile wireless access point product during the current season. Funding any additional unique content submissions in the area of wireless device technology could cause competition with the existing products on the market. Therefore, the decision-maker may decide that only three of the unique content submissions are worthy of capital investment.

In step S408, the unique content submissions determined to be worthy of capital investment (e.g., the three selected unique content submissions) are graduated and assigned an “above-the-line” value (e.g., 100 points). The other unique content submissions (e.g., the remaining seven unique content submissions) on the leader board are archived and are re-assigned a “below-the-line” value (e.g., 0 points). Accordingly, disincentive is introduced into the social networking environment. That is, to discourage voters from randomly assigning all of their accumulated points to each of the predetermined number of top-ranked unique content submissions, even top-ranked unique content submissions having a highest number of votes, are assigned a below-the-line vote value if deemed unworthy, by the decision-maker, of capital investment.

As noted above, an escrow feature is implemented just prior to and during the time at which the decision-maker is making a provisional decision, i.e., in steps S404 and S406. That is, users cannot vote on, invest in, or sell stock in the unique content submissions displayed on the leader board. In step S410, the user's accumulated points are updated to reflect the new vote values for the ranked unique content submissions on the leader board. Accordingly, accumulated points are reflective of the predictive market performance of the unique content submissions in which the user has invested.

For example, a user has 360 points in his or her user account and invests 50 points in each of two of the above-described wireless networking unique content submissions, 15 points in a home office solution unique content submission and 35 points in a mobile device unique content submission. That is, the user invests a total of 150 points (i.e., in step S404). In the above-described example, the wireless networking unique content submissions and the mobile device unique content submissions are determined, by the decision-maker, to be archived and assigned zero points. Therefore, the user loses 135 points and gains 85 points for net total of 310 points in his or her user account. The home office solution is determined, by the decision maker, to be worthy of capital investment, and therefore is graduated and assigned an above-the-line value, for example, 100 points. In a non-limiting embodiment, the user does not lose all the points corresponding to shares purchased in an archived unique content submission, and only loses a subset of the points used to purchase the shares. In another non-limiting embodiment, the above-the-line value is a multiplier of a vote total for the unique content submissions.

In FIG. 4B, an exemplary leader board for the process flow diagram described in FIG. 4A is shown. In particular, home office printing solution, home office networking solution and home office bundling solution are shown as “above-the-line” unique content submissions that have been ranked 1-3 and are given above-the-line vote values of 100 points each. The above-described decision-maker did not graduate unique content submissions corresponding to ad hoc wireless network access, wireless network security, 802.1x wireless networking protocol, mobile device interoperability, touch-screen mobile devices, data mining using mobile devices and media usage on a mobile device; these unique content submissions are archived and assigned below-the-line vote values of 0 points each. Even though ad hoc wireless network access and wireless network security unique content submissions had more votes than two of the above-the-line unique content submissions, that is, each of these content submission were more popular with the “crowd” than home office printing solution and home office networking solution unique content submissions, the decision-maker provisionally determined these unique content submissions to be below the line. The below-the-line unique content submissions are ranked in order of the number of votes received. In one non-limiting embodiment, the below-the-line unique content submission are ranked, by the decision-maker, in an order that does not correspond to the number of votes received.

In one non-limiting embodiment, the leader board shown in FIG. 4B is transparent to all users of the social networking interface. The leader board shown in FIG. 4B is also associated with a hashtag identifier that is not visible to the user. In one non-limiting embodiment, the hashtag identifier is visible to the user. The hashtag identifier is used to associate unique content submissions displayed on a leader board with each other. In another non-limiting embodiment, the hashtag identifier is used to associate unique content submissions within a category with each other. In yet another non-limiting embodiment, the user is enabled to search for unique content submissions by entering a selected hashtag identifier. The hashtag identifier for the leader board shown in FIG. 4B is “CONSUMER_SOLUTIONS_SUMMER_CONTEST_{—}2010”. As will be understood by one of ordinary skill in the art, the hashtag identifier may be descriptive of the unique content submissions displayed on the leader board. The hashtag identifier is linked and unique to each leader board. The hashtag identifier presents an opportunity to solicit votes during a timed event (e.g., a contest). For example, voting may be opened for a predetermined time period (e.g., two hours), to all users in the organizational entity.

Distributed Instances of the Innovation Pipeline

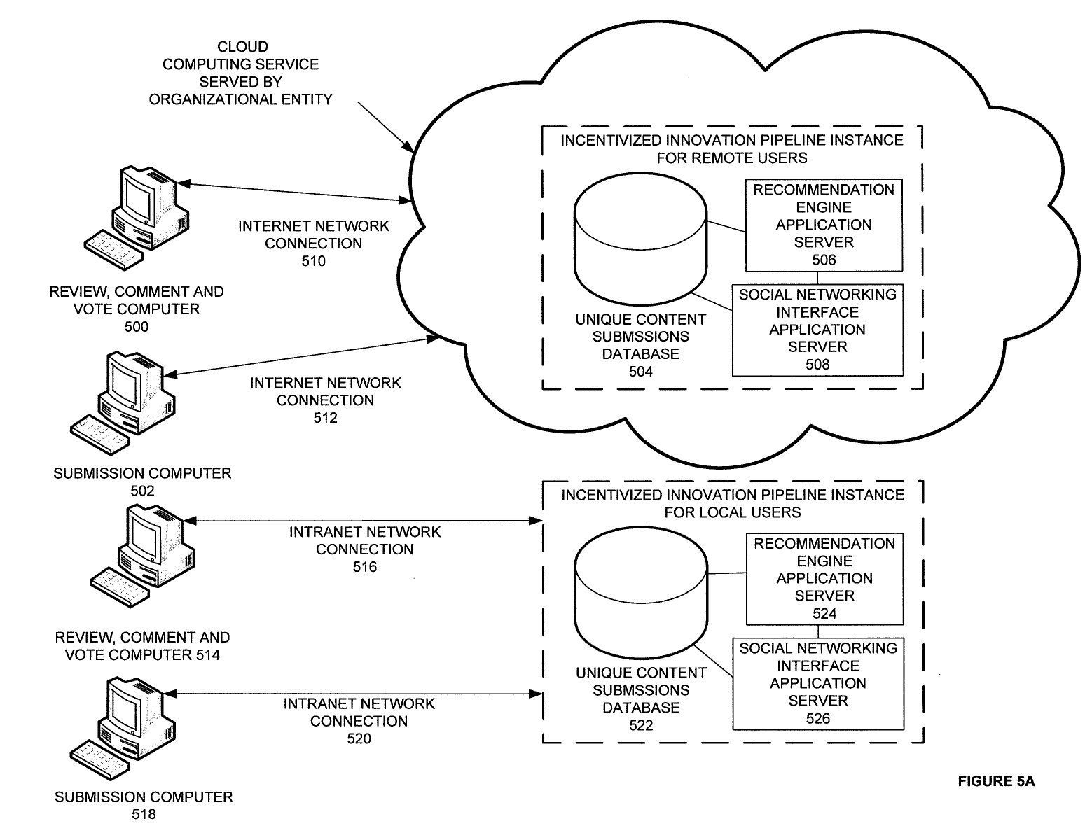

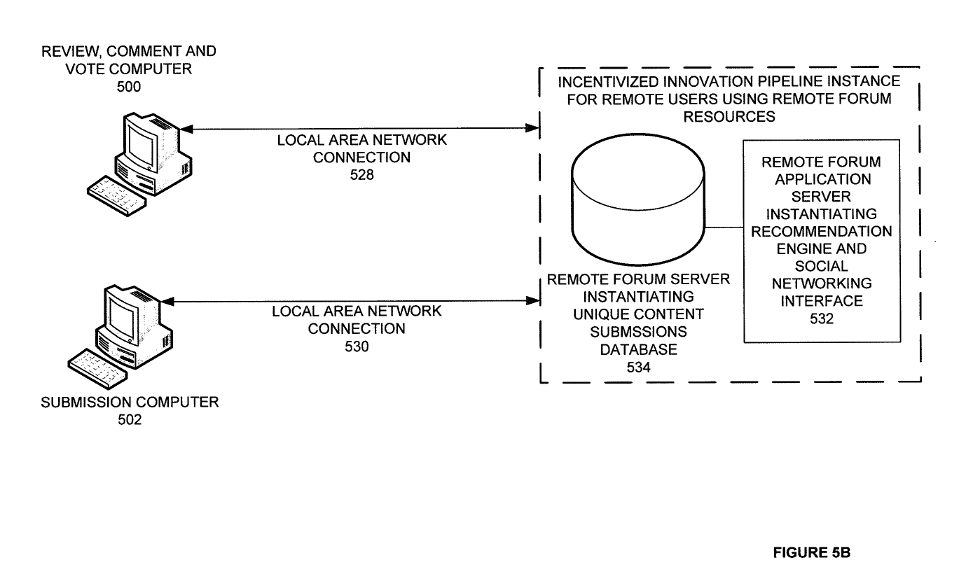

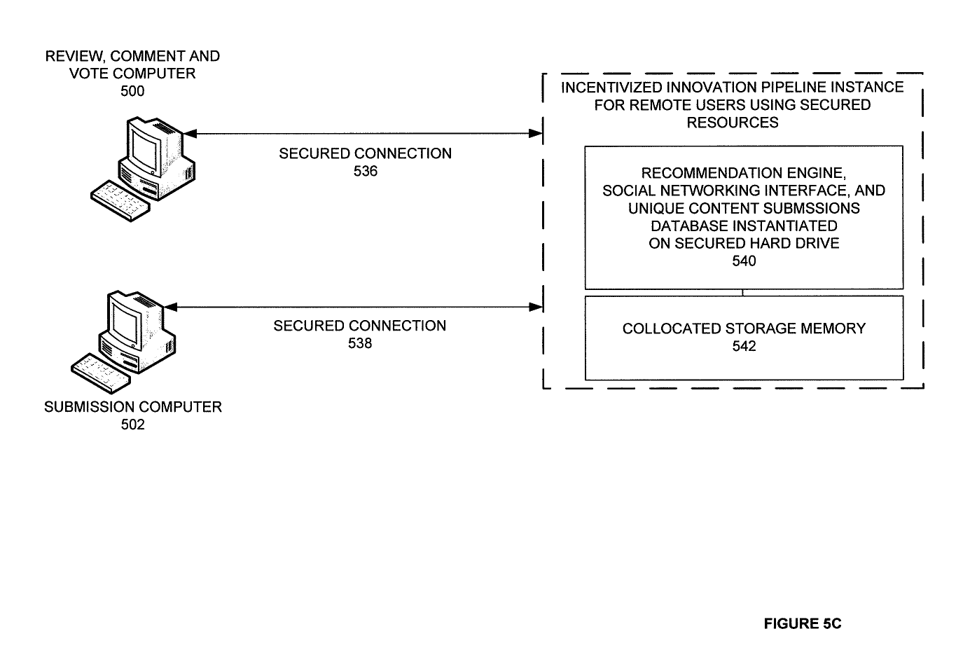

Sometimes, the social networking interface for submitting and reviewing unique content submissions is not accessible via a local area network connection. In such case, the functionality of the incentivized innovation pipeline is provided in alternative manners. In a first embodiment, users of the incentivized pipeline are located remotely from the organizational entity or from the hardware that supports the incentivized innovation pipeline. For example, users may be attending a conference at a remote location, during which and at which they wish to submit unique content submissions. In FIG. 5A, a first instance of an incentivized innovation pipeline including a unique content submissions database 504, a recommendation engine application server 506 and a social networking interface application server 508 are shown as being remotely accessible via the Internet. In particular, review, comment and vote computer 500 accesses a cloud computing service for the organizational entity via an internet network connection 510 and submission computer 502 accesses the cloud computing service via an Internet network connection 512. Remotely located users, either associated with the organizational entity or authorized by the organizational entity, are able to access the incentivized innovation pipeline via the cloud computing service. For example, users at a technology forum access the incentivized innovation pipeline instance served by the organizational entity.

In FIG. 5A, the organizational entity creates a cordoned set of resources for use by users at the technology forum, or other remotely located venue that is separate from the resources used by local users. For example, review, comment and vote computer 514 and submission computer 518 for local users access a different instance of the incentivized innovation pipeline, that is, a different set of unique content submissions database 522, recommendation engine application server 524 and social networking interface application 526 at the same organizational entity. That is, the remote users do not access the same hardware and software resources as the local users. In another non-limiting embodiment, remote and local users access the same hardware and software resources maintained by the organizational entity. In yet another non-limiting embodiment, remote users access a subset of the hardware and software resources accessible by the local users. In still another non-limiting embodiment, remote user capabilities with respect to any of the following, but not limited to: submitting, voting on, reviewing and commenting on unique content submissions are limited in comparison to capabilities of local users.

A second instance of the incentivized innovation pipeline is shown as being supported by remotely located resources in FIG. 5B. For example, the technology forum may be located at a remote venue that provides servers, switches and Wi-Fi antennas. Accordingly, a wired or wireless local area network or intranet may be established, using a remote venue's hardware and downloaded or portable versions of incentivized innovation pipeline software. Software associated with establishing a unique content submission database, recommendation engine and social networking interface is downloaded at the remote venue by bringing the software on a portable medium or media, for example, any of the following, but not limited to: a CD, a nonvolatile flash memory and a disk drive. Alternatively, the software is download from an email server, a hypertext transfer protocol (HTTP) server or a file transfer protocol (FTP) server maintained by the organizational entity.

In any event, the incentivized innovation pipeline software is installed on the remote venue's hardware resources to establish a local instance of the recommendation engine, the social networking interface and the unique content submissions database. In FIG. 5B, the recommendation engine and the social networking interface are instantiated on a single, remote forum server 532. The unique content submissions database is instantiated on another remote forum server 534. As will be understood by one of ordinary skill in the art, the unique content submissions database, the social networking interface and the recommendation engine are implementable on a single server. Review, comment and vote computer 500 connects to the incentivized innovation pipeline instance for remote users using forum resources via local area network connection 528 and submission computer 502 connects via local area network connection 530. As will be understood by one of ordinary skill in the art, the local area connections 528 and 530 may be wired or wireless.

As will also be understood by one of ordinary skill in the art, the remote venue may have more or less hardware resources available as compared to resources maintained by the organizational entity. The remote forum may also provide any of the following, but not limited to: networking hardware, storage hardware, load-balancing equipment and telephony equipment for establishing an instance of the incentivized innovation pipeline at the remote forum.

In one non-limiting embodiment, a website or other link associated with the incentivized innovation pipeline served by the organizational entity for the remote users or instantiated at the remote venue is broadcasted to social networking websites associated with the technology forum or to social networking handles associated with individual users at the technology forum. In another embodiment, the website or other link associated with the distributed instance of the incentivized innovation pipeline is distributed via proximity-based methods, e.g., via infrared or local area network channels.

A third instance of the innovation pipeline is shown as being an innovation pipeline supported by secured resources in FIG. 5C. In the illustrated example of the distributed incentivized innovation pipeline, review, comment and vote computer 500 and submission computer 502 are secured computers. For example, review, comment and vote computer 500 and submission computer 502 may be operated by a high-level government official discussing classified material. Rather than storing a distributed instance of the incentivized innovation pipeline at a remote venue or forum, the software associated with instantiating the incentivized innovation pipeline is downloaded from a first secured storage location to a second secured storage location. For example, the first secured storage location may be a nonvolatile flash memory, a CD, a hard disk drive, a secure server or a virtual private network. The second secured storage location may be a secured laptop computer or a secured server. In FIG. 5C, recommendation engine, social networking interface and unique content submissions database are implemented on a secured hard drive 540. In one embodiment, ideas submitted to the incentivized innovation pipeline and results of voting, commenting and reviewing unique content submissions are stored on the secured hard drive 540 and transferred to a collocated storage memory 542 (e.g., a nonvolatile flash drive) at a later time. Alternatively, results are transferred to the collocated storage memory 542, such that no data is stored on the secured hard drive 540. The review, comment and vote computer 500 and the submission computer 502 connect to the incentivized innovation pipeline instance for remote users using secured resources via secured connections 536 and 538. In one embodiment, secured connections 536 and 538 are dedicated wires. In another non-limiting embodiment, secured connections 536 and 538 carry encrypted data.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, although the description herein references multiple individual computers, local area networks and application servers, the descriptions herein would be applicable to subsequent or equivalent systems in which multiple or even all applications are provided by one or more application servers in a cloud environment provided by a third party. Similarly, the descriptions herein would be applicable to subsequent or equivalent systems in which individuals in an entity are distributed worldwide and each of the applications described herein is provided by one or more than one centralized application servers.

While a computer-readable medium herein may be shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols. For example, standards for power over ethernet represent an example of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for detecting and devaluing non-pertinent input in an online social network, comprising:
setting triggers for user conduct that includes evaluating a unique content submission submitted to the online social network;
detecting, at a tangible host server, when a trigger is activated based on user conduct by a first user;
penalizing the first user based on the user conduct; and
adjusting an initial weighting value assigned to the unique content submission submitted to the online social network based on the first user evaluating the unique content submission.

2. The method according to claim 1,
wherein the triggers are set in the online social network.

3. The method according to claim 2,
wherein the unique content submission is evaluated by at least one of a review, a vote and a comment submitted by the first user via the online social network.

4. The method according to claim 1,
wherein the trigger is activated when the user conduct conforms to at least one of evaluating more than a predetermined number of unique content submissions submitted to the online social network within a specified time period, evaluating the unique content submissions using less than a predetermined number of characters and using specified content in evaluating the unique content submissions.

5. The method according to claim 3,
wherein each of the review, the vote and the comment are associated with a different incentive.

6. The method according to claim 1,
wherein the first user loses a predetermined incentive amount from accumulated earned incentives when the trigger is activated.

7. The method according to claim 1, further comprising:
scoring the unique content submission in accordance with the adjusted weighting value.

8. The method according to claim 7,
wherein an evaluation of the unique content submission by the first user is scored differently than an identical evaluation of the unique content submission by a second user.

9. A method for scoring users in a social network, comprising:
providing the users with a vote corresponding to earned incentives for performing online activities;
accepting from the users, at a tangible host server, votes related to unique content submissions provided by the users;
ranking selected unique content submissions based on the votes;
provisionally evaluating ranked unique content submissions without further consideration of the votes;
graduating at least one unique content submission from provisionally evaluated unique content submissions;
adding to the earned incentives of users who voted for a graduated unique content submission; and
detracting from the earned incentives of users who voted for provisionally evaluated unique content submissions that were not graduated.

10. The method according to claim 9, further comprising:
investing in at least one ranked selected unique content submission by applying, by the users, a subset of the earned incentives to the at least one ranked selected unique content submission.

11. The method according to claim 9, further comprising:
suspending voting and investing during provisionally evaluating the ranked unique content submissions.

12. The method according to claim 10, further comprising:
adding to the earned incentives of the users who invested in the graduated unique content submission, based on the subset of the earned incentives; and
detracting from the earned incentives of users who invested in the provisionally evaluated unique content submissions that were not graduated, based on the subset of earned incentives.

13. The method according to claim 9,
wherein the ranked unique content submissions are displayed on a leader board.

14. The method according to claim 13,
wherein the leader board is associated with a hash tag identifier.

15. A method for presenting unique content submissions to users in a social network, comprising:
associating the unique content submissions with identifiers that correspond to characteristics of a plurality of authors of the unique content submissions;
obtaining characteristics of a first user in the social network;
obtaining a plurality of the unique content submissions from the plurality of authors;
determining, at a tangible host server, at least one best match among the unique content submissions for a first user based on obtained characteristics of the first user; and
presenting at least one best matched unique content submission to the first user preferentially over other unique content submissions via an online social networking interface based on the obtained characteristics of the first user and the identifiers corresponding to authors of the at least one best matched unique content submission.

16. The method according to claim 14, further comprising:
presenting at least one unique content submission to the first user based on characteristics of activity of the first user in the social network observed over a predetermined time period,
wherein the characteristics of the activity include categories associated with evaluated unique content submissions.

17. A method for evaluating unique content submissions generated by users, comprising:
collecting the unique content submissions, via at least one hardware resource, using a social networking website interface;
accepting reviews, votes and comments on the unique content submissions, via the at least one hardware resource, so as to rate the unique content submissions, using the social networking website interface; and
provisionally evaluating the unique content submissions based on the reviews, votes and comments,
wherein the social networking website interface is accessible by at least one remote user located remotely from an organizational entity.

18. The method according to claim 17,
wherein the at least one remote user accesses the social networking website interface via a cloud computing service established by the organizational entity, and
wherein the at least one hardware resource is located locally to the organizational entity.

19. The method according to claim 17,
wherein the at least one hardware resource is located remotely from the organizational entity and is proximate to the at least one remote user,
wherein the at least one hardware resource instantiates social networking software corresponding to the social network website interface, and
wherein the at least one remote user accesses the social networking website interface via the at least one hardware resource.

20. The method according to claim 19,
wherein the at least one hardware resource comprises a secured hardware device.
